(19) United States
(12) Patent Application Publication
(10) Pub. No.: US 2017/0026968 A1
(43) Pub. Date: Jan. 26, 2017

(54) Multiple Carrier Transmission on a Communication Channel

(71) Applicant: QUALCOMM Incorporated, San Diego, CA (US)

(72) Inventors: Hassan Kaywan Afkhami, San Jose, CA (US); Lawrence Winston Yonge, III, Summerfield, FL (US); Purva Rameshchandra Rajkotia, Orlando, FL (US)

(21) Appl. No.: 14/804,130

(22) Filed: Jul. 20, 2015

(51) Int. Cl. H04W 72/04; H04L 27/18; H04L 12/26; H04L 5/00; H04W 28/20; H04B 3/54

(52) U.S. Cl. CPC H04W 72/0453; H04W 28/20; H04B 3/54; H04L 43/16; H04L 5/006; H04L 27/18

(57) ABSTRACT

Described herein is an apparatus for communicating information via a communication channel from a first device to a second device. An apparatus may comprise an I/O module, and a processor coupled to the I/O module. The processor is configured to: determine a weak carrier associated with the communication channel; determine a strong carrier for pooling with the weak carrier and associated with the communication channel; determine information being transmitted on the strong carrier; and transmit the information on the weak carrier.

### TECHNICAL FIELD

The present application generally relates to transmission of information on a communication channel.

### BACKGROUND

A communication channel between a transmitting device and a receiving device may include one or more carriers, each carrier being associated with a carrier frequency. Some carriers are used more often than others in carrying information from the transmitting device to the receiving device. This is because some carriers have lower signal-to-noise (SNR) ratios compared to other carriers. There is an ever-present need to increase transmission rates and decrease error rates associated with the transmission of information from the transmitting device to the receiving device. In order to achieve these goals, there is a need to determine how to better utilize the carriers to communicate information from the transmitting device to the receiving device.

### SUMMARY

Described herein are various embodiments of communicating information via a communication channel from a first device to a second device. In an embodiment, an apparatus is provided for communicating information via a communication channel from a first device to a second device. The apparatus comprises an I/O module and a processor coupled to the I/O module. The processor is configured to: determine a weak carrier associated with the communication channel; determine a strong carrier for pooling with the weak carrier and associated with the communication channel; determine information being transmitted on the strong carrier; and transmit the information on the weak carrier. The apparatus as described herein may be located entirely in the first device, entirely in the second device, at least partially in the first device and at least partially in the second device, or entirely outside the first device and the second device. In an embodiment, the apparatus also comprises a memory that stores computer executable code for executing the various functions described herein.

In an embodiment, the communication channel is associated with a bandwidth equal to or greater than approximately 100 MHz and less than approximately 500 MHz.

In an embodiment, a difference between a frequency associated with the weak carrier and a frequency associated with the strong carrier is less than a threshold difference.

In an embodiment, a difference between a frequency associated with the strong carrier and a frequency associated with the weak carrier is less than a difference between the frequency associated with the weak carrier and each frequency associated with at least one strong carrier associated with the communication channel.

In an embodiment, the weak carrier has an SNR less than a first threshold SNR.

In an embodiment, the strong carrier has an SNR greater than a second threshold SNR.

In an embodiment, the weak carrier and the strong carrier are determined from a tone map transmitted from the first device to the second device prior to the information being transmitted on the strong carrier or the weak carrier, or a combination thereof.

In an embodiment, the information on the weak carrier is transmitted prior to, during, or after transmission of the information on the strong carrier.

In an embodiment, the information transmitted on the weak carrier is the same as the information transmitted on the strong carrier.

In an embodiment, the processor is further configured to determine an SNR associated with the transmitted information based on both the transmission of the information on the strong carrier and the transmission of the information on the weak carrier.

In an embodiment, the information is transmitted on the strong carrier and/or the information is transmitted on the weak carrier based on a phase-shift keying scheme.

In an embodiment, a method is provided for communicating information via a communication channel from a first device to a second device. The method comprises: determining, using a computing device processor of the first device, a weak carrier associated with the communication channel; determining, using the computing device processor, a strong carrier for pooling with the weak carrier and associated with the communication channel; determining, using the computing device processor, information being transmitted on the strong carrier; and initiating, using the computing device processor, transmission of or transmitting the information on the weak carrier. The computing device processor described herein may comprise multiple computing device processors.

In an embodiment, a computer readable medium is provided for providing instructions for communicating information via a communication channel from a first device to a second device. The computer readable medium comprises computer executable code configured to perform: determining a weak carrier associated with the communication channel; determining a strong carrier for pooling with the weak carrier and associated with the communication channel; determining information being transmitted on the strong carrier; and transmitting the information on the weak carrier.

### BRIEF DESCRIPTION OF THE DRAWINGS

Reference is now made to the following detailed description, taken in conjunction with the accompanying drawings. It is emphasized that various features may not be drawn to scale and the dimensions of various features may be arbitrarily increased or reduced for clarity of discussion. Further, some components may be omitted in certain figures for clarity of discussion.

FIG. 1 is a block diagram illustrating a network system for communicating between nodes;

FIG. 2 is a diagram of a system environment for communicating information via a communication channel from a first device to a second device; and

FIG. 3 is a diagram of a method for communicating information via a communication channel from a first device to a second device.

Although similar reference numbers may be used to refer to similar elements for convenience, it can be appreciated that each of the various example embodiments may be considered distinct variations.

### DETAILED DESCRIPTION

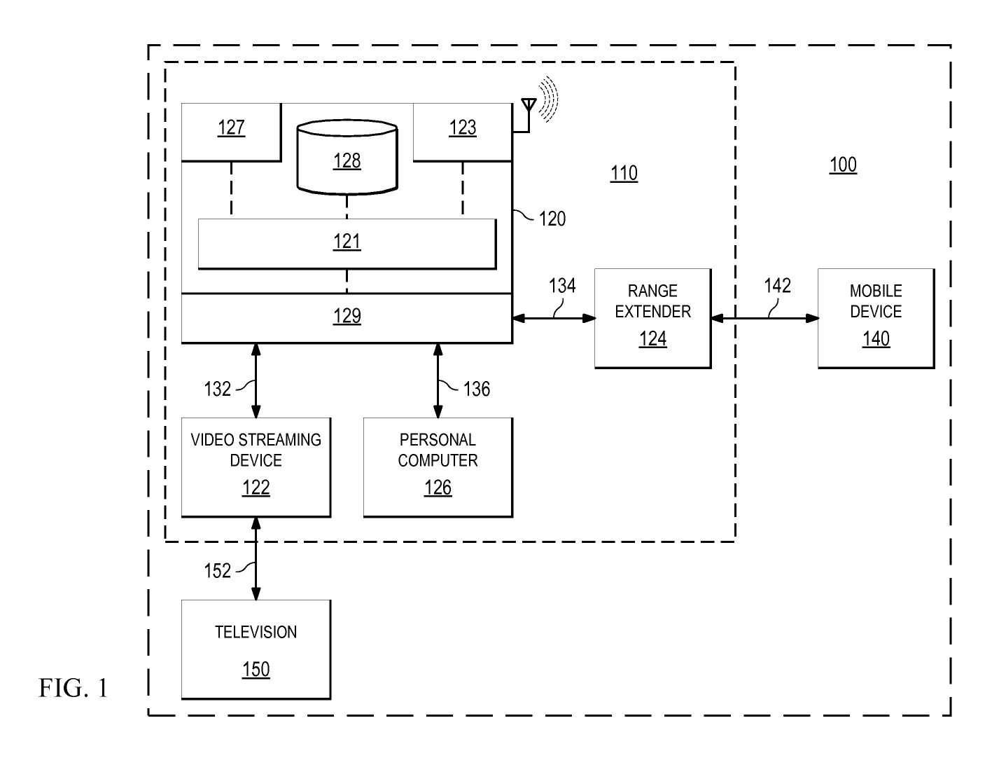

FIG. 1 shows a block diagram illustrating a system 100 for communicating between nodes on a network. The system 100 includes a powerline communication (PLC) network that may be deployed in a home, work place, automobile, or other environment having a powerline infrastructure. The system 100 may comprise an access point 120 that receives connectivity to an external network (e.g., the internet) via a port 127. The connectivity to the external network may be established via a wired connection or a wireless connection, which may use a cellular protocol such as a 2G, 3G, or 4G LTE protocol. The access point 120 may, for example, be an internet gateway router that may comprise a wireless transceiver 123 to provide wireless connectivity (e.g., Wi-Fi) to local devices in addition to the PLC connectivity described below. The access point 120 may additionally or alternatively comprise a wired transceiver (not shown) to provide wired connectivity (e.g., Ethernet) to local devices. In some embodiments, the access point 120 may utilize HomePlug® Access Broadband Power Line (BPL) protocols for coupling to a broadband backhaul network using the wiring of a public powerline infrastructure. Storage 128 may store computer executable instructions associated with any of the elements of FIG. 1.

The access point 120 may have a PLC modem 129 that enables it to transmit and receive messages over a plurality of PLC channels 132, 136, 134, forming a PLC network 110. The PLC network 110 may utilize an existing powerline infrastructure, and communications within the PLC network 110 may be implemented using a PLC protocol such as the HomePlug® 1.0, HomePlug® AV2, or the HomePlug® Green PHY protocols.

The access point 120 may communicate with a video streaming device 122 via the channel 132. The video streaming device 122 may deliver video data to a television 150 via a wired PLC or non-PLC channel 152, or wireless non-PLC channel 152. The access point 120 may further communicate with a range extender 124 via a PLC channel 134 or a wireless non-PLC channel. The range extender 124 may serve to extend the range of the home network provided, at least in part, by the access point 120. For example, if the access point 120 provides a Wi-Fi network having a limited range, the range extender 124 could be established at a location to extend the range of Wi-Fi connectivity. Alternatively, the range extender 124 could provide wired connectivity at a separate location from the access point 120. As shown in FIG. 1, the range extender 124 may provide a connection 142 (e.g., Wi-Fi) to a mobile device 140. The range extender 124 may effectively act as a bridge between the PLC network 110 and another network (e.g., Wi-Fi network).

The access point 120 may further communicate with a personal computer 126 via the PLC channel 136. The computer 126 may comprise or be connected to its own PLC modem that sends and receives signals on the PLC channel 136. The computer 126 may be used for a variety of applications that utilize local and/or internet connectivity including gaming, media sharing, and internet browsing. A network coordination processor 121 may implement a control strategy associated with the PLC network 110.

The various channels described with respect to FIG. 1 may have multiple carriers having corresponding frequencies. A channel carries one or more bits of information or data between a transmitting device (e.g., an access point 120) and a receiving device (e.g., a personal computer 126). The channel may also be referred to as the core channel. Transmitting devices and receiving devices on a network negotiate which carriers may be used to carry information (e.g., message payloads) and the bitrate for each carrier. This information may be codified in a tone map that is sent from the transmitting device to the receiving device prior to a message payload transmission from the transmitting device to the receiving device. The transmitting or receiving device may select, either singly or in combination with each other, the carrier-specific bitrates (e.g., the values conveyed in the tone map) based on estimated signal-to-noise ratios (SNR) for each carrier. If a carrier has an SNR that is insufficient for sending even a single bit, as is possible through Binary Phase Shift Keying (BPSK), the transmitting or receiving device may determine not to use that carrier (e.g., by setting the carrier's bitrate value to 0 in the tone map).

As used herein, a weak carrier is a carrier that has an SNR less than a first threshold SNR. A strong carrier has an SNR greater than a second threshold SNR. The strong carrier's SNR and the weak carrier's SNR may be relative. For example, the strong carrier's SNR may be two times the SNR of the weak carrier. The first threshold SNR may or may not be equal to the second threshold SNR. Some techniques “pool” or combine multiple weak carriers into groups with sufficient SNR for communication via BPSK, a scheme in which a single bit is transmitted from the transmitting device to the receiving device. However, these techniques rely upon SNR estimation for the weak carriers, which may be unreliable. Moreover, the total bandwidth of the channel is only marginally increased in a “pooling” technique. The present disclosure describes embodiments for providing improved bandwidth over these techniques.

The present disclosure provides embodiments for improving usage of weak carriers in a high bandwidth channel (e.g., approximately 100 MHz to approximately 500 MHz) and other challenging regimes. As used herein, a high bandwidth channel is a communication channel associated with a bandwidth equal to or greater than a threshold bandwidth (e.g., approximately 100 MHz), and less than a second threshold bandwidth (e.g., approximately 500 MHz). The present disclosure is not limited to a high bandwidth channel, and may be applied to an embodiment associated with any bandwidth. The channel may be used to transmit information between a transmitting device and a receiving device. Instead of pooling weak carriers with one another to transmit new bits on the channel, the weak carriers may be grouped with strong carriers to provide redundancy and improve overall communication robustness and reliability on the channel (e.g., the core channel). For example, each weak carrier may be pooled with the “closest” strong carrier (e.g., having the smallest frequency difference between the weak carrier and the strong carrier) and may send or repeat the same signal sent by the strong carrier, thereby increasing the total SNR of this signal and decreasing the bit error rate (BER) associated with sending the signal. The signal sent by the strong carrier may be sent before, simultaneously with, or after the signal sent by the weak carrier. By grouping weak carriers and strong carriers, design complexity may be decreased with respect to systems that selectively group potentially nonconsecutive weak carriers together.

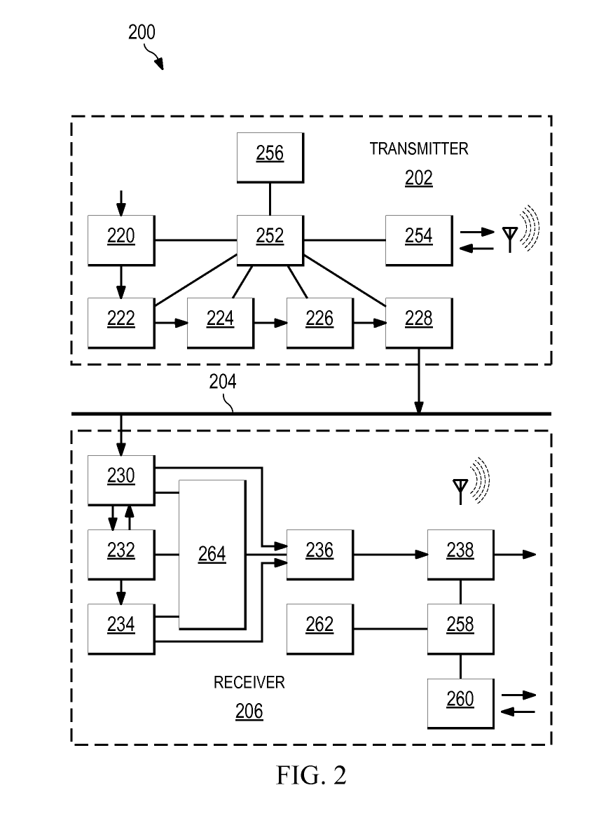

FIG. 2 shows a block diagram illustrating a communication system 200 for communicating over a network. Within the communication system 200, a transmitting device or transmitter 202 may transmit a signal (e.g., a sequence of orthogonal frequency-division multiplexing (OFDM) symbols) over a communication medium 204 to a receiving device or receiver 206. A symbol (e.g., an OFDM symbol) may include one or more bits. The transmitting device 202 and receiving device 206 may both be incorporated into any of the nodes of a network (e.g., a PLC network 110 of FIG. 1). The communication medium 204 may represent a path or channel from one node to another (e.g., over the powerline infrastructure). The communication system 200 and elements of the communication system 200 are for exemplary purposes only.

At the transmitting device 202, modules implementing the physical layer receive a MAC protocol data unit (MPDU) from the MAC layer. The MAC protocol data unit is sent to an encoder module 220 to perform processing of the MPDU such as scrambling, error correction coding, and interleaving.

The encoded data is fed into a mapping module 222 that takes groups of data bits (e.g., 1, 2, 3, 4, 6, 8, or 10 bits), depending on the constellation used for the current symbol (e.g., a BPSK, QPSK, 8-QAM, 16-QAM constellation), and maps the data value represented by those bits onto the corresponding amplitudes of in-phase (I) and quadrature-phase (Q) components of a carrier waveform of the current symbol. This results in each data value being associated with a corresponding complex number Cᵢ=Aᵢ exp(jΦᵢ) whose real part corresponds to the in-phase component and whose imaginary part corresponds to the quadrature-phase component of a carrier with a peak frequency, fᵢ. Alternatively, any appropriate modulation scheme that associates data values to modulated carrier waveforms may be used.

The mapping module 222 also determines which of the carrier frequencies f₁, f₂, f₃, . . . , f_{N} within the OFDM bandwidth are used by the system 200 to transmit information. For example, some carriers that are experiencing fades can be avoided, and no information is transmitted on those carriers. Instead, the mapping module 222 uses coherent BPSK modulated with a binary value from the Pseudo Noise (PN) sequence for that carrier. In an embodiment, the mapping module 222 repeats transmission, on a weak carrier, of the same information transmitted on a strong carrier. For some carriers (e.g., a carrier i=10) that correspond to restricted bands (e.g., an amateur radio band) on the medium 204 that may radiate power, substantially no energy may be transmitted on those carriers (e.g., by setting A₁₀=0). The mapping module 222 also determines the type of modulation to be used on each of the carriers (or “tones”) according to a tone map. The tone map can be a default tone map, or a customized tone map determined by the receiving device.

An inverse discrete Fourier transform (IDFT) module 224 performs the modulation of the resulting set of N complex numbers (some of which may be zero for unused carriers) determined by the mapping module 222 onto N orthogonal carrier waveforms having peak frequencies f₁, f₂, f₃, . . . , f_{N}. The modulated carriers are combined by the IDFT module 224 to form a discrete time symbol waveform S(n) (for a sampling rate f_{R}), which can be written as

$$S ( n ) = 10 {\sum }_{i = 1}^{N} {A}_{i} exp [ j ( 2 π n / N + {Φ}_{i} ) ] \qquad Eq . ( 1 )$$

where the time index n goes from 1 to N, Aᵢ is the amplitude and Φᵢ is the phase of the carrier with peak frequency fᵢ=(i/N)f_{R}, and j=√−1. In some embodiments, the discrete Fourier transform corresponds to a fast Fourier transform (FFT) in which N is a power of 2.

A processing module 226 combines a sequence of consecutive (potentially overlapping) symbols into a symbol set that can be transmitted as a continuous block over the communication medium 204. The processing module 226 prepends a preamble to the symbol set that can be used for automatic gain control (AGC) and symbol timing synchronization. To mitigate intersymbol and intercarrier interference (e.g., due to imperfections in the system 200 and/or the communication medium 204), the processing module 226 can extend each symbol with a cyclic prefix that is a copy of the last part of the symbol. The processing module 226 can also perform other functions such as applying a pulse shaping window to subsets of symbols within the symbol set (e.g., using a raised cosine window or other type of pulse shaping window) and overlapping the symbol subsets.

An analog front end (AFE) module 228 couples an analog signal comprising a continuous-time (e.g., low-pass filtered) version of the symbol set to the communication medium 204. The effect of the transmission of the continuous-time version of the waveform S(t) over the communication medium 204 can be represented by convolution with a function g(τ;t) representing an impulse response of transmission over the communication medium. The communication medium 204 may add noise n(t), which may be random noise and/or narrowband noise emitted by a jammer.

At the receiving device 206, modules implementing the physical layer receive a signal from the communication medium 204 and generate a MAC protocol data unit for the MAC layer. An AFE module 230 operates in conjunction with an automatic gain control (AGC) module 232 and a time synchronization module 234 to provide sampled signal data and timing information to a discrete Fourier transform (DFT) module 236.

After removing the cyclic prefix, the receiving device 206 feeds the sampled discrete-time symbols into DFT module 236 to extract the sequence of N complex numbers representing the encoded data values (by performing an N-point DFT). A demodulator/decoder module 238 maps the complex numbers onto the corresponding bit sequences and performs the appropriate decoding of the bits (including de-interleaving and descrambling).

Any of the modules of the communication system 200 including modules in the transmitting device 202 or receiving device 206 can be implemented in hardware, software, or a combination of hardware and software. Where a module is implemented, at least in part, in software, the software may be stored in a non-volatile, machine-readable medium.

While the communication medium has generally been described as a powerline infrastructure, alternative embodiments may also use the phone lines or coaxial cables (e.g., inside a house) as a communication medium. In some cases, there could be variation in signal attenuation and noise characteristics between various pairs of nodes. In such cases, systems may use channel adaptation procedures that enable selection of unique physical layer encoding parameters (e.g., modulation rate and forward error correction code rate) between a given pair of nodes. This approach enables optimization of the physical data rate that can be achieved between the pair of nodes according to current channel characteristics.

In some embodiments, the channel characteristics depend on an attenuation (and distortion) of the signal as it propagates from the transmission to the receiving device. The channel characteristics may also depend on noise within the network. The combined effect of signal attenuation (and distortion) and noise may determine the channel capacity that may be achieved between a pair of nodes. Higher channel capacity allows for more data intensive applications to be supported and/or for lower noise emissions by allowing decreased transmission power. The channel characteristics may also determine quality of a channel or how reliably information is transmitted across the channel. Indicators and measures of quality may include, for example, BER or symbol error rate (SER). In general, a low quality channel is prone to distorting the messages it conveys while a high quality channel preserves the integrity of the messages it conveys. In some embodiments, the quality of the channel in use between communicating entities governs the probability of the receiving device correctly receiving the message from the transmitting device.

A processor 252 may control any of the other modules and/or functions performed by the various modules in the transmitting device 202. A processor 264 or 258 may control any of the other modules and/or functions performed by the various modules in the receiving device 206. While processors 264 and 258 are shown separately, they could represent either distinct processors or a single processor. Any actions described as being taken by a processor may be taken by the processor alone or by the processor in conjunction with one or more additional components. Additionally, while only one processor may be shown in certain devices, multiple processors may be present. Thus, while instructions may be discussed as being executed by a processor, the instructions may be executed simultaneously, serially, or otherwise by one or multiple processors. A processor may be implemented as one or more CPU chips and may be a hardware device capable of executing computer instructions. The processor may execute instructions, codes, computer programs, or scripts. The instructions, codes, computer programs, or scripts may be received from an I/O module 254 or from memory 256 for the transmitting device 202, and from the I/O module 260 or from memory 262 for the receiving device 206.

As used herein, an I/O module 254 or 260 may include modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, universal mobile telecommunications system (UMTS) radio transceiver devices, long term evolution (LTE) radio transceiver devices, worldwide interoperability for microwave access (WiMAX) devices, and/or other well-known devices for connecting to networks. I/O modules may also include liquid crystal displays (LCDs), touch screen displays, keyboards, keypads, switches, dials, mice, track balls, voice recognizers, card readers, paper tape readers, printers, video monitors, or other well-known input/output devices.

As used herein, memory 256 or 262 may include random access memory (RAM), read only memory (ROM), or various forms of secondary storage. RAM may be used to store volatile data and/or to store instructions that may be executed by a processor. ROM may be a non-volatile memory device that may have a smaller memory capacity than the memory capacity of a secondary storage. ROM may be used to store instructions and/or data that may be read during execution of computer instructions. Access to both RAM and ROM may be faster than access to secondary storage. Secondary storage may be comprised of one or more disk drives or tape drives and may be used for non-volatile storage of data or as an over-flow data storage device if RAM is not large enough to hold all working data. Secondary storage may be used to store programs that may be loaded into RAM when such programs are selected for execution.

As used herein, networks may represent any form of communication network between connected machines and any other network elements, and may also represent a collection of machines or virtual machines operable to provide cloud computing services to users. Networks may include a public cloud or a private cloud. Networks may include routers, hubs, switches, firewalls, content switches, gateways, call controllers, and/or any other suitable components in any suitable form or arrangement. Networks may include, in whole or in part, one or more secured and/or encrypted Virtual Private Networks (VPNs) operable to couple one or more network elements together by operating or communicating over elements of a public or external communication network. A network as described herein may be a wired or wireless network.

A node may include any device with a network interface, which includes, but is not limited to, a network component, a desktop computer, a laptop, a mobile device, a television, a watch or wristband, a laptop computer, a smart screen, a tablet computer, a desktop computer, an electronic reader, a scanner, a portable media player, a mobile computing device, a mobile phone, a wearable device (e.g., wearable on a user's arm), headgear, a gaming device, or a kiosk. A node may be a virtual machine, computer, device, instance, host, or machine in a networked computing environment. As used herein, the terms node, device, system, and apparatus are equivalent and may be used interchangeably.

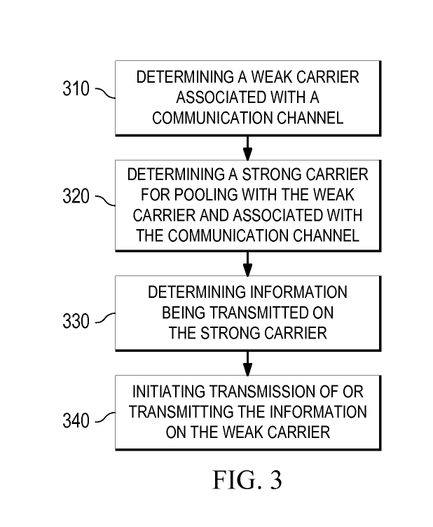

FIG. 3 is a diagram of an embodiment of a method for communicating information (e.g., comprising at least one bit) via a communication channel (e.g., a wired or wireless communication channel) from a first device (e.g., a transmitting device or transmitter) to a second device (e.g., a receiving device or receiver). The disclosure herein may be used with any communication channel, and is not limited to high bandwidth channels. The communication channel may be associated with a network such as a PLC network 110. An exemplary communication channel includes a Digital Subscriber Line (DSL) connection. At block 310, the method comprises determining a weak carrier associated with the communication channel (e.g., a high bandwidth channel). A weak carrier is a carrier that has an SNR less than a first threshold SNR. A strong carrier has an SNR greater than a second threshold SNR. In an embodiment, the first threshold SNR is equal to the second threshold SNR. In another embodiment, the first threshold SNR is less than but not equal to the second threshold SNR. In another embodiment, the weak carrier has an SNR greater than a third threshold SNR. The third threshold SNR is less than both the first and second threshold SNRs. This means that the weak carrier has an SNR greater than the minimum threshold SNR required for carrying information (e.g., one bit of information).

At block 320, the method comprises determining a strong carrier for pooling with the weak carrier and associated with the communication channel. In an embodiment, a difference between a frequency associated with the weak carrier and a frequency associated with the strong carrier is less than a threshold difference. In another embodiment, a difference between a frequency associated with the strong carrier and a frequency associated with the weak carrier is less than a difference between the frequency associated with the weak carrier and each frequency associated with at least a plurality of other strong carriers on the channel. Therefore, the determined strong frequency carrier may be associated with the closest strong frequency to the frequency of the determined weak carrier. The strong carrier frequency that is closest in frequency to the weak carrier frequency may be either greater than or less than the weak carrier frequency.

In an embodiment, the weak carrier and the strong carrier are determined in a tone map transmitted from the first device to the second device prior to the information being transmitted on the strong carrier or the weak carrier. The tone map establishes usability and bitrates of multiple carriers on the channel between the first device and the second device. The weak carrier and the strong carrier may be determined (e.g., using and/or interpreting the tone map) entirely by the first device, entirely by the second device (e.g., after receiving the tone map from the first device), or by the first and second devices, in combination and communication with each other. For example, the first device may determine the strong carrier and the weak carrier from a plurality of carriers, and the second device can then identify the strong and weak carriers by interpreting the tone map. In an embodiment, additionally or alternatively, the first device or the second device assigns a strong carrier's bitrate to a weak carrier.

At block 330, the method comprises determining information being transmitted on the strong carrier. At block 340, the method comprises initiating transmission of or transmitting the information (e.g., the same information that is transmitted on the strong carrier) on the weak carrier. The information on the weak carrier is transmitted prior to, during, or after transmission of the information on the strong carrier.

SNR estimation of information transmitted using the embodiments described herein may be adapted to reflect a group of carriers having both a strong carrier and one or more weak carriers that are transmitting a common signal. Such an SNR estimation may be referred to as an effective SNR estimation. This carrier group may produce a higher effective SNR than the strong carrier does individually, and this may allow for an increased bitrate with respect to the bitrate if the strong carrier was used by itself. Therefore, in an embodiment, the method further comprises determining an effective SNR associated with the transmitted information on the strong carrier based on both the transmission of the information on the strong carrier and the transmission of the information on the weak carrier. In an embodiment, the information transmitted on the strong carrier may be repeated on multiple weak carriers. Such an embodiment also leads to an increased effective SNR for the transmitted information.

The combining of the information transmitted on the strong and weak carriers leads to an increase of the SNR per transmitted bit. The increase in SNR per transmitted bit leads to an increase in the transmission rate (number of bits transmitted per unit time) between the transmitting device and the receiving device.

While various embodiments in accordance with the disclosed principles have been described above, it should be understood that they have been presented by way of example only, and are not limiting. Thus, the breadth and scope of the embodiments should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Various terms used herein have special meanings within the present technical field. Whether a particular term should be construed as such a “term of art,” depends on the context in which that term is used. “Connected to,” “in communication with,” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings herein are provided for consistency with the suggestions under 37 C.F.R. 1.77 or otherwise to provide organizational cues. These headings shall not limit or characterize the embodiments set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any embodiments in this disclosure. Neither is the “Summary” to be considered as a characterization of the embodiments set forth in issued claims. Furthermore, any reference in this disclosure to “embodiment” in the singular should not be used to argue that there is only a single point of novelty in this disclosure. Multiple embodiments may be set forth according to the limitations of the multiple claims issuing from this disclosure, and such claims accordingly define the embodiments, and their equivalents, that are protected thereby. In all instances, the scope of such claims shall be considered on their own merits in light of this disclosure, but should not be constrained by the headings herein.

What is claimed is:

1. An apparatus for communicating information via a communication channel from a first device to a second device, the apparatus comprising:
an I/O module; and
a processor coupled to the I/O module, the processor configured to:
determine a weak carrier associated with the communication channel;
determine a strong carrier for pooling with the weak carrier and associated with the communication channel;
determine information being transmitted on the strong carrier; and
transmit the information on the weak carrier.

2. The apparatus of claim 1, wherein the communication channel is associated with a bandwidth equal to or greater than approximately 100 MHz and less than approximately 500 MHz.

3. The apparatus of claim 1, wherein a difference between a frequency associated with the weak carrier and a frequency associated with the strong carrier is less than a threshold difference.

4. The apparatus of claim 1, wherein a difference between a frequency associated with the strong carrier and a frequency associated with the weak carrier is less than a difference between the frequency associated with the weak carrier and each frequency associated with at least one strong carrier associated with the communication channel.

5. The apparatus of claim 1, wherein the weak carrier has a signal-to-noise ratio (SNR) less than a first threshold SNR.

6. The apparatus of claim 1, wherein the strong carrier has an SNR greater than a second threshold SNR.

7. The apparatus of claim 1, wherein the weak carrier and the strong carrier are determined from a tone map transmitted from the first device to the second device prior to the information being transmitted on the strong carrier or the weak carrier, or a combination thereof.

8. The apparatus of claim 1, wherein the information on the weak carrier is transmitted prior to, during, or after transmission of the information on the strong carrier.

9. The apparatus of claim 1, wherein the information transmitted on the weak carrier is the same as the information transmitted on the strong carrier.

10. The apparatus of claim 1, wherein the processor is further configured to determine an SNR associated with the transmission of the information based on both the transmission of the information on the strong carrier and the transmission of the information on the weak carrier.

11. The apparatus of claim 1, wherein the information is transmitted on the strong carrier based on a phase-shift keying scheme.

12. The apparatus of claim 1, wherein the communication channel comprises a wired communication channel.

13. The apparatus of claim 1, wherein the communication channel comprises a wireless communication channel.

14. The apparatus of claim 1, wherein the information is transmitted on the weak carrier based on a phase-shift keying scheme.

15. A method for communicating information via a communication channel from a first device to a second device, the method comprising:
determining, using a computing device processor of the first device, a weak carrier associated with the communication channel;
determining, using the computing device processor, a strong carrier for pooling with the weak carrier and associated with the communication channel;
determining, using the computing device processor, information being transmitted on the strong carrier; and
initiating, using the computing device processor, transmission of the information on the weak carrier.

16. The method of claim 15, wherein a difference between a frequency associated with the strong carrier and a frequency associated with the weak carrier is less than a difference between the frequency associated with the weak carrier and each frequency associated with at least one strong carrier associated with the communication channel.

17. The method of claim 15, further comprising determining, using the computing device processor, the weak carrier and the strong carrier from a tone map; and transmitting, using the computing device processor, the tone map from the first device to the second device prior to the information being transmitted on the strong carrier or the weak carrier, or a combination thereof.

18. The method of claim 15, wherein the information being transmitted on the weak carrier is the same as the information being transmitted on the strong carrier.

19. The method of claim 15, wherein the computing device processor comprises multiple computing device processors.

20. A computer readable medium for communicating information via a communication channel from a first device to a second device, the computer readable medium comprising computer executable code configured to perform:
determining a weak carrier associated with the communication channel;
determining a strong carrier for pooling with the weak carrier and associated with the communication channel;
determining information being transmitted on the strong carrier; and
transmitting the information on the weak carrier.
